(19) United States
(12) Patent Application Publication
(10) Pub. No.: US 2020/0195022 A1
(43) Pub. Date: Jun. 18, 2020

(54) CHARGING STATION FOR EASY CONNECTION

(71) Applicant: Oxti Corporation, Taipei (TW)

(72) Inventor: Chih Feng HO, Taipei (TW)

(21) Appl. No.: 16/223,183

(22) Filed: Dec. 18, 2018

(51) Int. Cl. H02J 7/00

(52) U.S. Cl. CPC H02J 7/0027; H02J 7/0045; H02J 7/0044

(57) ABSTRACT

A charging station includes a carrier having a base plate and having an upper surface, a back plate extended upwardly from a rear portion of the base plate and having a front surface, a number of pogo pin connector devices attached to the back plate, and a number of housings are engaged onto the upper surface of the base plate and the front surface of the back plate, and aligned with the pogo pin connector devices respectively, and the housings each include a chamber formed in the housing for receiving a mobile device. The upper surface of the base plate and the front surface of the back plate are inclined relative to a bottom surface of the base plate and perpendicular to each other.

### BACKGROUND OF THE INVENTION

### 1. Field of the Invention

The present invention relates to a charging station or charging cart or charging facility, and more particularly to a charging station including an improved structure or configuration for allowing the mobile devices, such as tablets, notebooks, or chromebooks, etc., to be easily and quickly and readily disposed or engaged into the charging station by children, for example.

### 2. Description of the Prior Art

Typical charging stations or charging carts or charging facilities comprise a container or storage rack disposed or engaged in a mobile cabinet or reservoir or the like for receiving or engaging with various mobile devices, such as tablets, notebooks, or chromebooks, etc., and for allowing the mobile devices to be easily and quickly connected or coupled to the electric sources or reservoirs or the like.

For example, U.S. Pat. No. 6,008,621 to Madison et al., U.S. Pat. No. 8,320,110 to Chen, and U.S. Pat. No. 9,130,385 to Chen disclose several of the typical charging stations or charging carts or charging facilities each also comprising a storage rack or the like disposed or engaged in a mobile cabinet for receiving or engaging with various mobile devices, such as tablets, notebooks, or chromebooks, etc., and for allowing the mobile devices to be easily and quickly connected or coupled to the electric sources or reservoirs or the like.

However, the storage rack or the container for receiving or engaging with the mobile devices have no guiding structures or configurations formed or provided therein for guiding the mobile devices to engage into the storage rack, such that the mobile devices may not be easily and quickly engaged into the charging station, particularly by the children.

The present invention has arisen to mitigate and/or obviate the afore-described disadvantages of the conventional charging stations or charging carts.

### SUMMARY OF THE INVENTION

The primary objective of the present invention is to provide a charging station including an improved structure or configuration for allowing the mobile devices, such as tablets, notebooks, or chromebooks, etc., to be easily and quickly and readily disposed or engaged into the charging station by children, for example.

In accordance with one aspect of the invention, there is provided a charging station comprising a carrier including a base plate having an upper surface, a back plate extended upwardly from a rear portion of the base plate and having a front surface, a number of first pogo pin connector devices attached to the back plate of the carrier, and a number of housings engaged onto the upper surface of the base plate and the front surface of the back plate, and aligned with the first pogo pin connector devices respectively, and the housings each including a chamber formed in the housing for receiving a mobile device and for allowing the mobile device to be easily engaged with the first pogo pin connector device.

The upper surface of the base plate is tilted from a higher front portion toward a lower rear portion of the base plate. The front surface of the back plate is inclined relative to a bottom surface of the base plate. The upper surface of the base plate is preferably perpendicular to the front surface of the back plate.

The carrier includes a number of openings formed in the front surface of the back plate and aligned with the first pogo pin connector devices respectively, and the first pogo pin connector devices each include a number of pogo pins extended into the opening of the back plate respectively for engaging with the mobile device. The first pogo pin connector devices each include a terminal for connecting to an electric cable.

The housings each include a lower panel, an upper panel, and two side panels for forming the chamber of the housing, and for forming an opened front portion and an opened rear portion, for allowing the mobile device to be engaged into the chamber of the housing. The housings each include at least one spring biasing member extended into the chamber of the housing for engaging with the mobile device.

The mobile device includes a terminal, and a second pogo pin connector is engaged with the terminal of the mobile device for engaging with the first pogo pin connector device. The carrier includes a number of stops extended upwardly from a front portion of the base plate and aligned with the first pogo pin connector devices respectively for solidly and stably anchoring and positioning the housings on the base plate of the carrier.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a charging station in accordance with the present invention;

FIG. 2 is a perspective view of the charging station;

FIG. 3 is an enlarged partial perspective view of the charging station;

FIG. 4 is a front plan schematic view illustrating a mobile device, such as a tablet to be engaged with the charging station in accordance with the present invention;

FIGS. 5, 6 are plan schematic views illustrating the operation of the charging station; and

FIGS. 7, 8 are perspective views illustrating the operation of the charging station.

### DETAILED DESCRIPTION OF THE PREFERRED EMBODIMENT

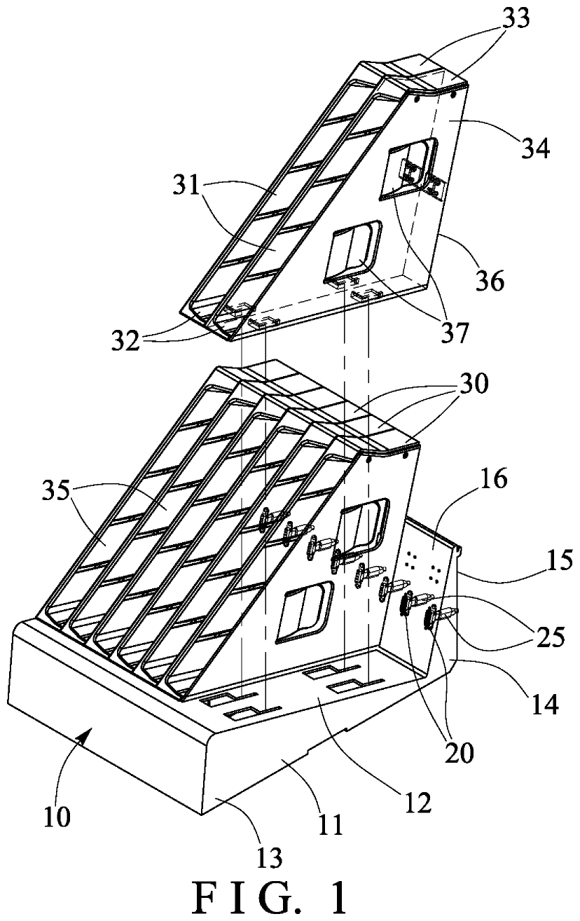

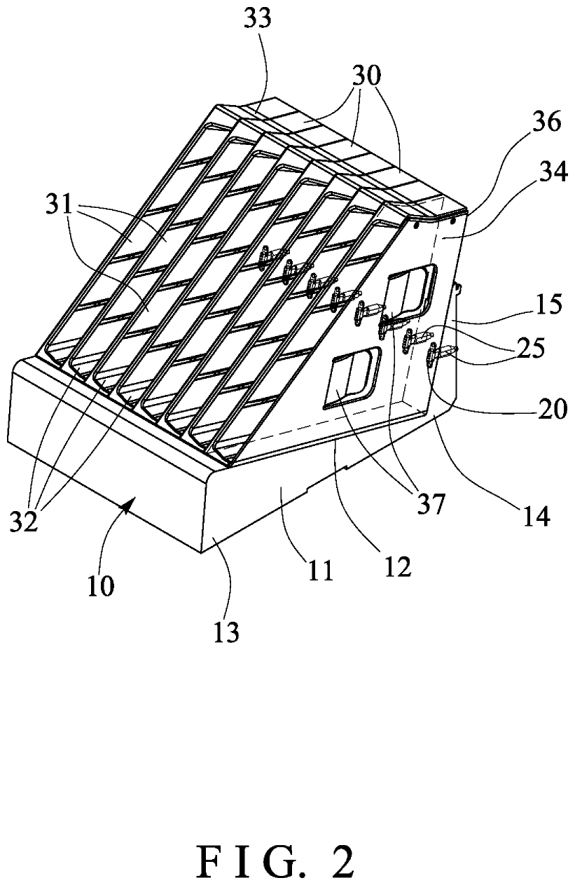

Referring to the drawings, and initially to FIGS. 1-3, a charging station or charging cart or charging facility in accordance with the present invention comprises a base member or carrier 10 including a base plate or platform 11 having a tilted or inclined upper surface 12 formed or provided on the upper portion thereof and tilted or inclined downwardly from the higher front portion 13 toward the lower rear portion 14, and including a rear wall or back plate 15 extended upwardly from the rear portion 14 of the base plate 11 and having a tilted or inclined front surface 16 formed or provided on the front portion thereof and intersected or communicated or connected or coupled to the tilted upper surface 12 of the base plate 11, it is preferable, but not necessary that the upper surface 12 of the base plate 11 and the front surface 16 of the back plate 15 are perpendicular to each other. It is further preferable, but not necessary that the tilted upper surface 12 of the base plate 11 is tilted or inclined relative to the lower or bottom surface 18 of the base plate 11 for an included angle “A” (FIG. 6) ranging between 10 and 30 degrees. The front surface 16 of the back plate 15 is also tilted or inclined relative to the lower or bottom surface 18 of the base plate 11.

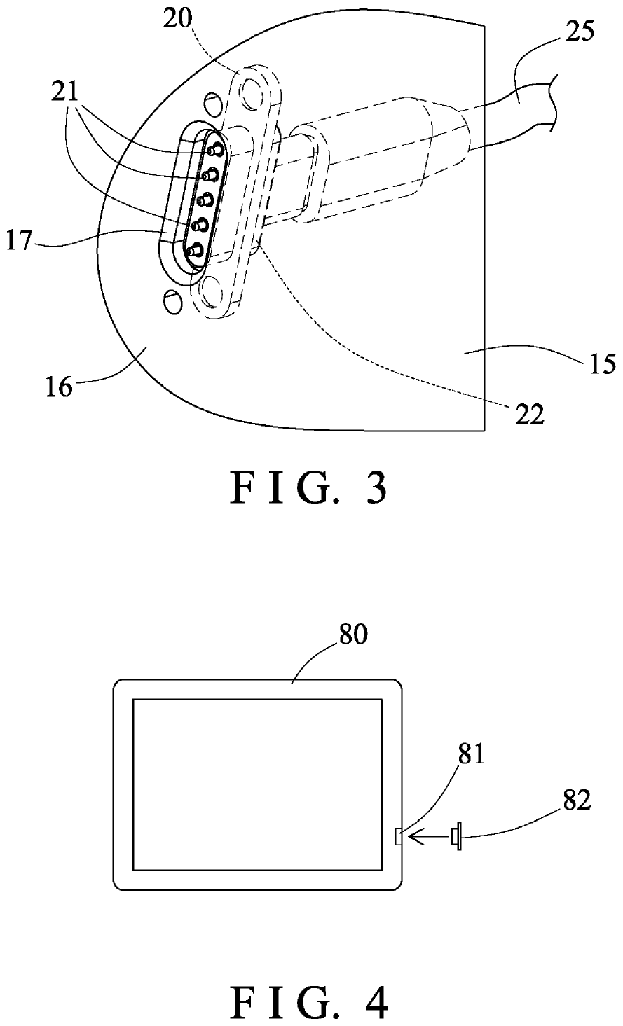

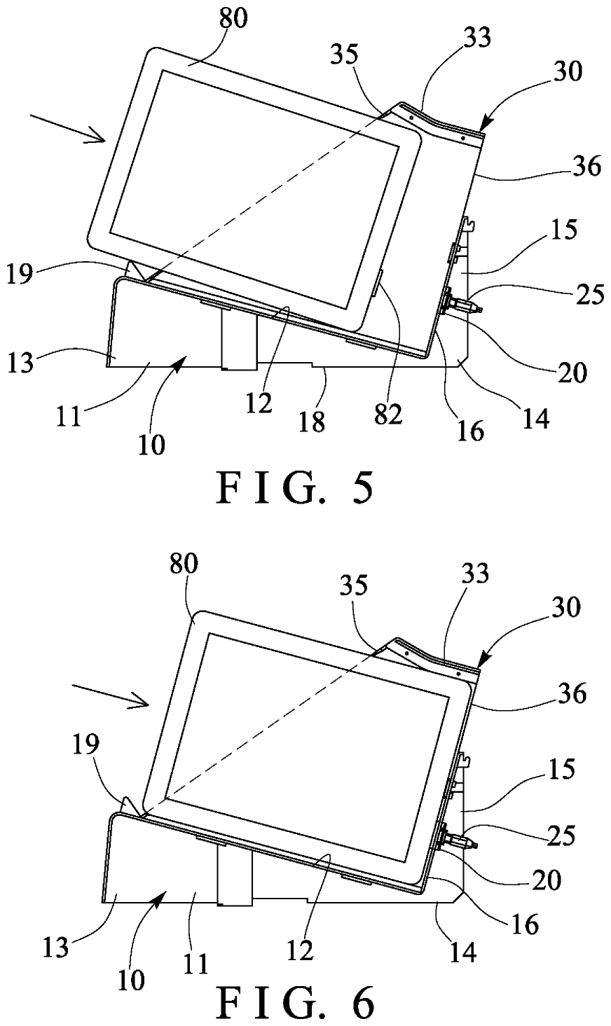

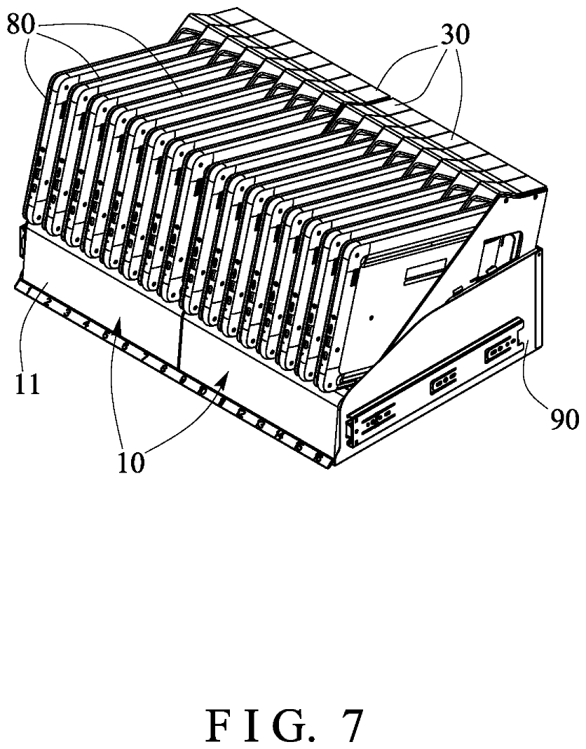

The carrier 10 further includes one or more, or a number of orifices or openings 17 formed in the front portion or front surface 16 of the back plate 15 (FIGS. 1, 3). One or more, or a number of male spring loaded connectors or first or male pogo pin connector devices 20 are attached or mounted or secured to the back plate 15 of the carrier 10, and each include a number of terminals or pogo pins 21 extended and/or engaged into the respective opening 17 of the back plate 15, best shown in FIG. 3, for engaging with various mobile devices, such as tablets 80 (FIGS. 4-6), notebooks, or chromebooks, or the like. For example, the tablet or mobile device 80 includes a terminal 81 connected or coupled to or engaged with a female spring loaded connector or second or female pogo pin connector 82 for connecting or coupling to or for engaging with the male pogo pin connector device 20, best shown in FIGS. 5-6. It is preferable that the carrier 10 further includes one or more, or a number of projections or stops 19 extended upwardly from the front portion 13 of the base plate 11 and aligned with the openings 17 of the back plate 15 and the male pogo pin connector devices 20 respectively.

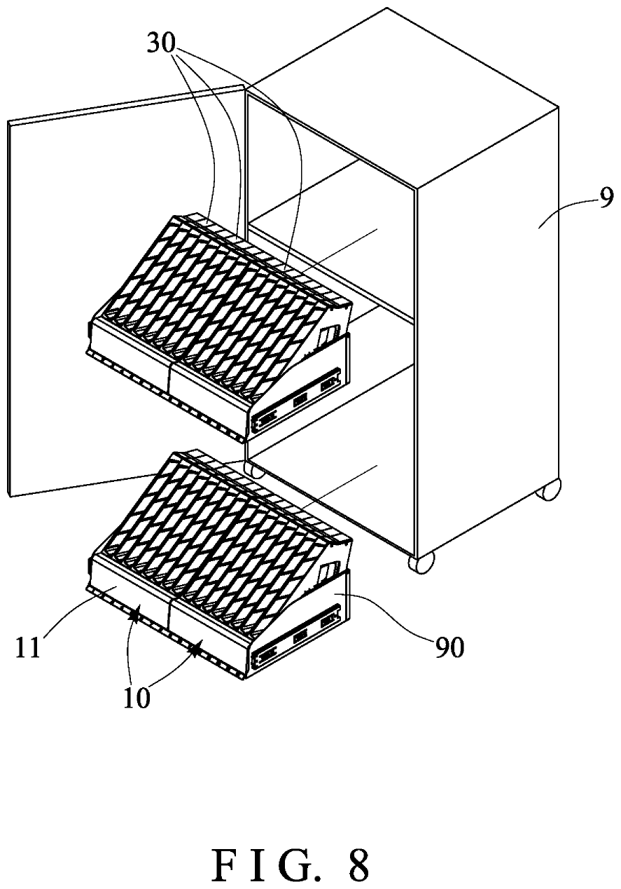

The male pogo pin connector devices 20 each further include another connector or terminal 22 (FIG. 3) for selectively connecting or coupling to or for engaging with the electric wire or electric cable 25 which may be selected from a USB type C electric cable, a Miracast, an Airplay, an AiDi, a Chromecast, or a DLNA, or the like for suitably supplying the electric sources or energies to the male pogo pin connector device 20 and the female pogo pin connector 82 and the terminal 81 of the mobile device 80 selectively. Similarly, the terminals 22 of the male pogo pin connector devices 20 and the terminals 81 of the mobile devices 80 and the female pogo pin connectors 82 may also be selected from a USB type C connecter, a Miracast, an Airplay, an AiDi, a Chromecast, or a DLNA, or the like. In operation, as shown in FIGS. 7 and 8, one or more carriers 10 may be disposed or engaged into a container or tray 90 before the carriers 10 and the container or tray 90 are disposed or engaged into a mobile charging cart or charging facility 9.

The charging station in accordance with the present invention further comprises one or more, or a number of magazines or housings 30 to be disposed or engaged onto the upper surface 12 of the base plate 11 and the front surface 16 of the back plate 15, and to be aligned with the openings 17 of the back plate 15 and the male pogo pin connector devices 20 respectively, and to be contacted or engaged with the stops 19 of the base plate 11 (FIG. 6) for allowing the housings 30 to be solidly and stably anchored or retained or positioned and supported on the base plates 11 of the carriers 10. The housings 30 each include a compartment or chamber 31 formed therein, and formed or defined by a lower or bottom wall or panel 32, an upper wall or panel 33, and two side walls or panels 34, and for forming or defining an opened front portion 35 and an opened rear portion 36, for allowing the mobile devices 80 to be engaged into the chambers 31 of the housings 30, and for allowing the terminals 81 of the mobile devices 80 and the female pogo pin connectors 82 to be connected to or engaged with the pogo pins 21 of the male pogo pin connector devices 20.

It is further preferable, but not necessary that the opened front portion 35 of the housing 30 is tilted or inclined relative to the lower or bottom panel of the housing 30 for allowing the mobile device 80 to be easily and quickly and readily disposed or engaged into the chamber 31 of the housing 30, and for allowing the mobile device 80 to be partially extended out of the housing 30 (FIGS. 5, 6), and thus for allowing the terminals 81 of the mobile devices 80 and the female pogo pin connectors 82 to be easily and quickly and readily forced to be connected to or engaged with the pogo pins 21 of the male pogo pin connector devices 20. It is preferable that the housings 30 each include one or more spring biasing blades or spring biasing members 37 extended into the chamber 31 of the housing 30 for engaging with the mobile device 80 and for solidly and stably anchoring or retaining or positioning the mobile device 80 within the chamber 31 of the housing 30.

In operation, as shown in FIG. 6, the housings 30 may be disposed or engaged onto the upper surface 12 of the base plate 11 and the front surface 16 of the back plate 15, and may be contacted or engaged with the stops 19 of the base plate 11 for allowing the housings 30 to be solidly and stably anchored or retained or positioned and supported on the base plates 11 of the carriers 10. As shown in FIG. 5, the mobile device 80 may be easily and quickly and readily disposed or engaged into the chamber 31 of the housing 30 from the opened and tilted front portion 35 of the housing 30, and the terminals 81 of the mobile devices 80 and the female pogo pin connectors 82 may be easily and quickly and readily forced to be connected to or engaged with the pogo pins 21 of the male pogo pin connector devices 20 (FIG. 6). As shown in FIGS. 7 and 8, one or more carriers 10 may be disposed or engaged into the container or tray 90 before the carriers 10 and the container or tray 90 are disposed or engaged into the mobile charging cart or charging facility 9.

Accordingly, the charging station in accordance with the present invention includes an improved structure or configuration for allowing the mobile devices, such as tablets, notebooks, or chromebooks, etc., to be easily and quickly and readily disposed or engaged into the charging station by children, for example.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A charging station comprising:
a carrier including a base plate having an upper surface, a back plate extended upwardly from a rear portion of said base plate and having a front surface,
a plurality of first pogo pin connector devices attached to said back plate of said carrier, and
a plurality of housings engaged onto said upper surface of said base plate and said front surface of said back plate, and aligned with said first pogo pin connector devices respectively, and said housings each including a chamber formed in said housing for receiving a mobile device.

2. The charging station as claimed in claim 1, wherein said upper surface of said base plate is tilted from a higher front portion toward a lower rear portion of said base plate.

3. The charging station as claimed in claim 1, wherein said front surface of said back plate is inclined relative to a bottom surface of said base plate.

4. The charging station as claimed in claim 1, wherein said upper surface of said base plate is perpendicular to said front surface of said back plate.

5. The charging station as claimed in claim 1, wherein said carrier includes a plurality of openings formed in said front surface of said back plate and aligned with said first pogo pin connector devices respectively, said first pogo pin connector devices each include a plurality of pogo pins extended into said opening of said back plate respectively.

6. The charging station as claimed in claim 1, wherein said first pogo pin connector devices each include a terminal for connecting to an electric cable.

7. The charging station as claimed in claim 1, wherein said housings each include a lower panel, an upper panel, and two side panels for forming said chamber of said housing, and for forming an opened front portion and an opened rear portion, for allowing said mobile device to be engaged into said chamber of said housing.

8. The charging station as claimed in claim 7, wherein said housings each include at least one spring biasing member extended into said chamber of said housing for engaging with said mobile device.

9. The charging station as claimed in claim 1, wherein said mobile device includes a terminal, and a second pogo pin connector is engaged with said terminal of said mobile device for engaging with said first pogo pin connector device.

10. The charging station as claimed in claim 1, wherein said carrier includes a plurality of stops extended upwardly from a front portion of said base plate and aligned with said first pogo pin connector devices respectively.
